(19) United States
(12) Patent Application Publication
(10) Pub. No.: US 2019/0364909 A1
(43) Pub. Date: Dec. 5, 2019

(54) Formed Cooked Batter Food Containment System

(71) Applicant: Powdr Corp., Park City, UT (US)

(72) Inventors: Todd Stevenson, Louisville, CO (US); Jeff Suffolk, Louisville, CO (US)

(73) Assignee: Powdr Corp., Park City, UT (US)

(21) Appl. No.: 16/431,408

(22) Filed: Jun. 4, 2019

Related U.S. Application Data
(60) Provisional application No. 62/680,120, filed on Jun. 4, 2018.

(51) Int. Cl. A21B 5/02; B65D 65/46; A21D 13/33; A21C 11/00

(52) U.S. Cl. CPC A21B 5/026; A21C 11/00; A21D 13/33; B65D 65/463

(57) ABSTRACT

A system for cooking and forming an edible food container includes include a bottom housing and a top housing. The bottom housing comprises a press receiver defining at least one press receptacle and the top housing comprises a press defining at least one press protrusion. The system further includes a heating element incorporated into at least one of the top housing and the bottom housing. The system also includes a frame, with the top housing being moveable relative to the bottom housing via engagement with the frame.

### CROSS-REFERENCE TO RELATED APPLICATIONS

This application claims priority to, and the benefit of, U.S. provisional patent application Ser. No. 62/680,120 filed Jun. 4, 2018 and entitled “Formed Cooked Batter Food Containment System,” the entire contents of which are incorporated herein by reference in their entirety for all purposes.

### FIELD

The present disclosure relates to edible containers, and more specifically to apparatuses, systems, and methods for forming edible containers.

### BACKGROUND

Food containers, such as take-home boxes and/or plastic bags, generally become waste products after being used to store food. That is, conventional food containers are often configured for single use (e.g., disposable), and thus conventional food containers are waste products that contribute to the growing problem of excess landfill waste.

### SUMMARY

Disclosed herein, according to various embodiments, is an apparatus for cooking and forming an edible food container. The apparatus may include a bottom housing comprising a press receiver defining at least one press receptacle. The apparatus may also include a top housing comprising a press defining at least one press protrusion, wherein the top housing is moveable relative to the bottom housing. Still further, the apparatus may include a heating element incorporated into at least one of the top housing and the bottom housing.

Also disclosed herein, according to various embodiments, is a system for cooking and forming an edible food container. The system may include a bottom housing comprising a press receiver defining at least one press receptacle and a top housing comprising a press defining at least one press protrusion. The system may further include a heating element incorporated into at least one of the top housing and the bottom housing. The system may further includes a frame, with the top housing being moveable relative to the bottom housing via engagement with the frame.

In various embodiments, the top housing comprises a handle, the frame comprises a guide track, and the handle of the top housing is received within the guide track. The guide track may also include a notch configured to securely yet reversibly retain the handle, and thus the top housing, in a removed position relative to the bottom housing. In various embodiments, the guide track comprises a first vertical portion such that movement of the top housing relative to the bottom housing is a linear upward translation.

Also disclosed herein, according to various embodiments, is a method for cooking and forming an edible food container. The method may include removing a top housing a distance from a bottom housing, pouring a batter into at least one press receptacle defined by a press receiver of a the bottom housing, and approximating the top housing relative to the bottom housing to compress the batter between walls of the at least one press receptacle and a press protrusion of a press of the top housing. In various embodiments, removing the top housing the distance from the bottom housing comprises a linear upward translation of the top housing relative to the bottom housing.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

FIG. 1 depicts a perspective top-down view of a cooked batter food containment system, in accordance with various embodiments;

FIG. 2 depicts a perspective bottom-up view of a cooked batter food containment system, in accordance with various embodiments;

FIG. 3 depicts alternate views of a press receiver of a cooked batter food containment system, in accordance with various embodiments;

FIG. 4 depicts alternative views of a press of a cooked batter food containment system, the press featuring nine press protrusions, in accordance with various embodiments;

FIG. 5 depicts a press featuring four press protrusions, in accordance with various embodiments;

FIG. 6 depicts a bottom housing of a cooked batter food containment system, in accordance with various embodiments;

FIG. 7 depicts a removable tray, which may include a press receiver, of a cooked batter food containment system, in accordance with various embodiments;

FIG. 8 depicts a press receiver with four press protrusion receptacles, in accordance with various embodiments;

FIG. 9 depicts a press with nine press protrusions and a corresponding press receiver with nine press protrusion receptacles, in accordance with various embodiments;

FIG. 10 depicts a stand displayed with a bottom housing and a top housing, in accordance with various embodiments;

FIG. 11 depicts a press incorporating a plurality of heating element apertures centrally located within each of the press protrusions and a corresponding press receiver, in accordance with various embodiments;

FIG. 12 depicts a heating element, in accordance with various embodiments;

FIG. 13 depicts a disassembled top housing configured to accommodate wiring, in accordance with various embodiments;

FIG. 14 depicts a press and corresponding press receiver, in accordance with various embodiments;

FIG. 15 depicts an assembled construct featuring a top housing, a press, a press receiver, and a bottom housing, in accordance with various embodiments;

FIG. 16 depicts a side view of a press and other components, in a deconstructed view, in accordance with various embodiments;

FIG. 17 depicts a side view of a heating element placed within a heating element aperture connected to a wire, in accordance with various embodiments;

FIG. 18 depicts a top down view of a press receiver featuring a gripping tooth aperture, in accordance with various embodiments;

FIG. 19 depicts a perspective view of a cooked batter food containment system, in accordance with various embodiments;

FIG. 20 depicts a side perspective view of a cooked batter food containment system, in accordance with various embodiments;

FIG. 21 depicts a perspective view of a cooked batter food containment system with a press separated a distance from a press receiver, in accordance with various embodiments; and

FIG. 22 depicts a perspective view of a cooked batter food containment system in an open configuration with a press retained in secure position, in accordance with various embodiments.

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the inventions, it should be understood that other embodiments may be realized and that logical changes and adaptations in design and construction may be made in accordance with the present inventions and the teachings herein. Thus, the detailed description herein is presented for purposes of illustration only and not of limitation. The scope of the present inventions is defined by the appended claims.

In various embodiments, the present disclosure provides an apparatus, system, and method for forming edible food containers. As used herein, the terms “formed cooked batter food containment system,” “cooked batter food containment system,” “the system,” and “the apparatus” refer generally to one or more components/devices for cooking batter and forming edible food containers from the cooked batter, as described in greater detail below.

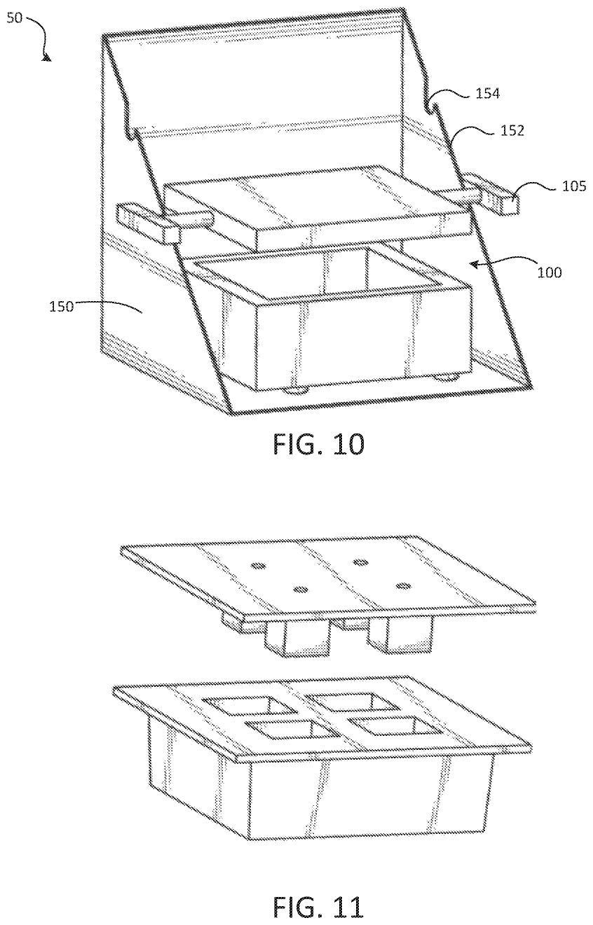

In various embodiments, and with reference to FIG. 10, a system 50 for forming edible food containers is provided. The system 50 generally includes an apparatus 100 for cooking batter and a frame 150 for retaining portions of the apparatus in one or more desired positions during use of the apparatus 100, according to various embodiments. Generally, the system 50 is configured to allow a user to make edible food containers. For example, a user may utilize waffle batter in conjunction with the system 50 to cook and form “waffle boxes” for holding/containing food (e.g., other breakfast items, such as eggs, bacon, syrup, condiments, etc.). Accordingly, the term “batter,” as used herein, refers to a pre-cooked, semi-liquid mixture of food material that can be placed within the system/apparatus to be cooked and formed into edible containers.

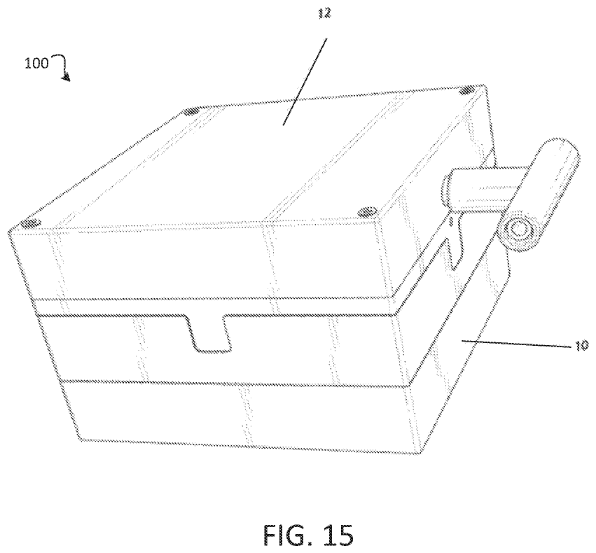

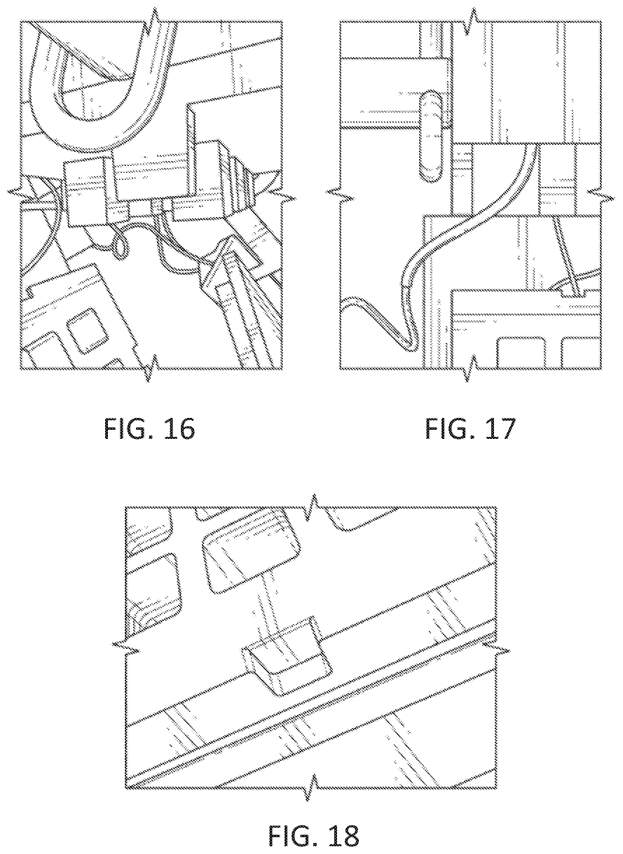

In various embodiments, and with reference to FIG. 15, the apparatus 100 includes a bottom housing 10 and a top housing 12. Generally, the top housing 12 may be moveable relative to the bottom housing 10 to enable batter to be poured between the top housing 12 and the bottom housing 10. The bottom housing 10 may be referred to as a base and the top housing 12 may be referred to as a lid. The top housing 12 may be coupled to the bottom housing 10 using a hinge or other pivoting mechanism. In various embodiments, and as described in greater detail below, the top housing is not directly coupled to the bottom housing, and instead may include handles 105 or other features that are configured to movably slide along a guide track 152 of the frame 150. The guide track 152 of the frame 150 may facilitate movement of the top housing 12 relative to the bottom housing 10, and may facilitate securing the top housing 12 in a removed position (e.g., the handles 105 may be received within the slot(s) 154), relative to the bottom housing 10, while a user pours in batter, or after the batter has been cooked and the user extracts the cooked edible container.

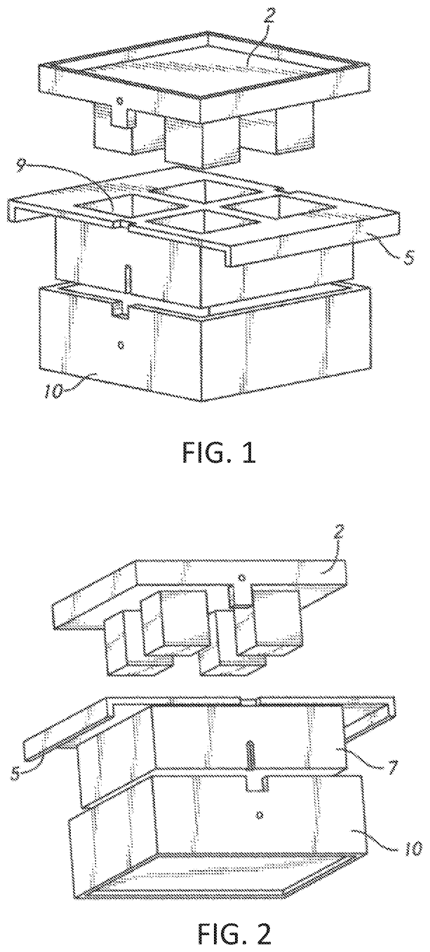

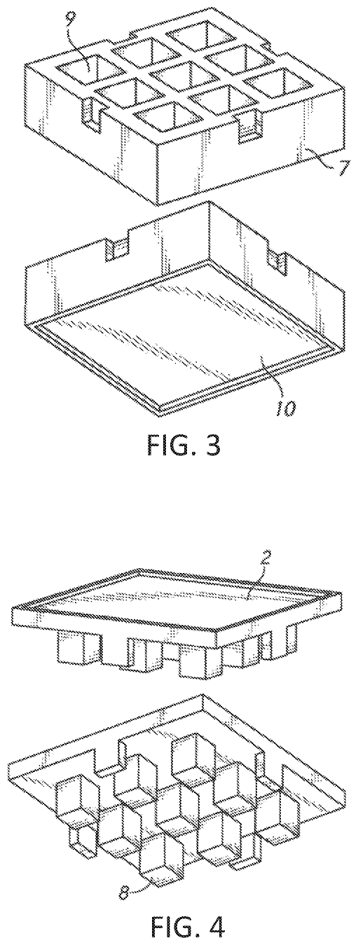

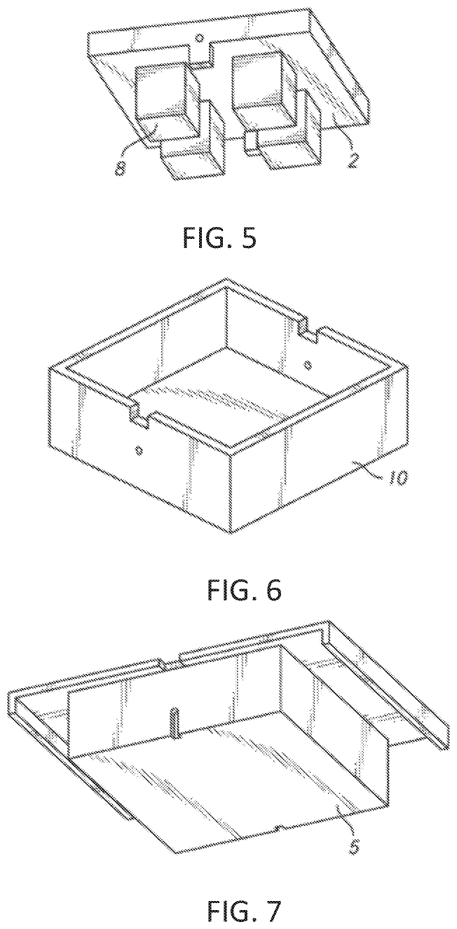

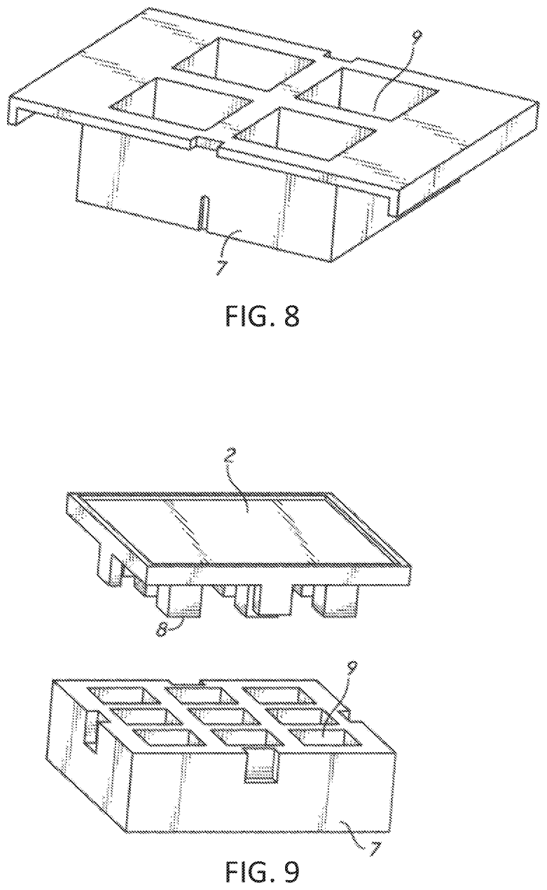

In various embodiments, and with reference to FIGS. 1-9 and 11, the apparatus 100 includes a press 2 and a press receiver 7. The press 2 generally includes one or more protrusions 8 that are configured to be at least partially inserted into protrusion receptacles 9 defined in the press receiver 7. In various embodiments, the press 2 is coupled/mounted to the top housing 12 and the press receiver 7 is coupled to, mounted to, received within, and/or seated relative to the bottom housing 10. For example, the press receiver 7 may be a removable tray 5 detachably engaged with the bottom housing 10 of the apparatus 100. The removable tray 5 may facilitate extraction of the cooked, formed, edible containers, and/or may facilitate cleaning the apparatus/system. The number of protrusions 8 of the press 2 may correspond to the number of protrusion receptacles of the press receiver 7. In various embodiments, the apparatus 100 includes 4 pairs of protrusions/protrusion receptacles. In various embodiments, the apparatus 100 includes 9 pairs of protrusions/protrusion receptacles. The number of pairs of protrusions/protrusion receptacles is not limited to the implementations depicted herein. Additionally, the size, shape, and orientation, of the protrusions and protrusion receptacles are not limited to the what is shown in the accompanying figures.

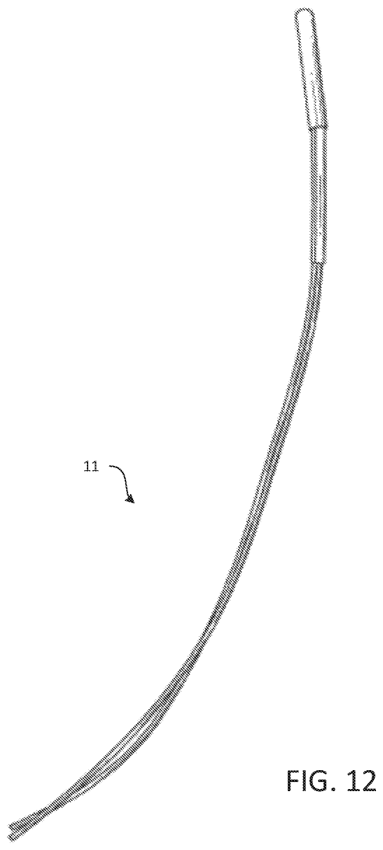

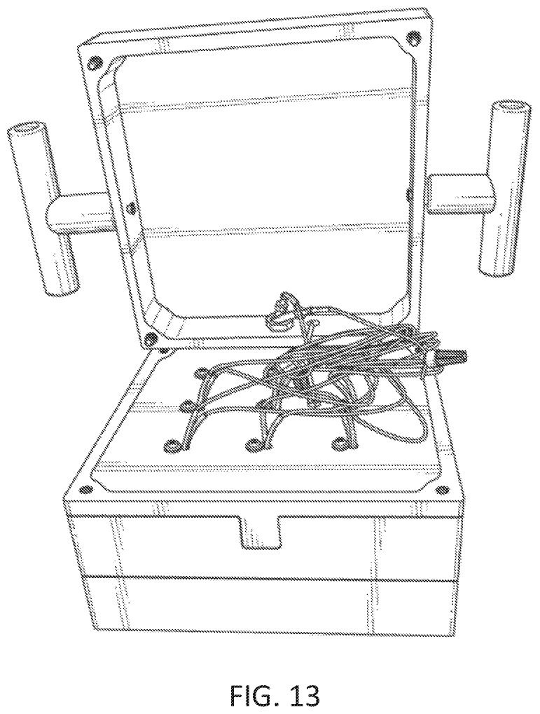

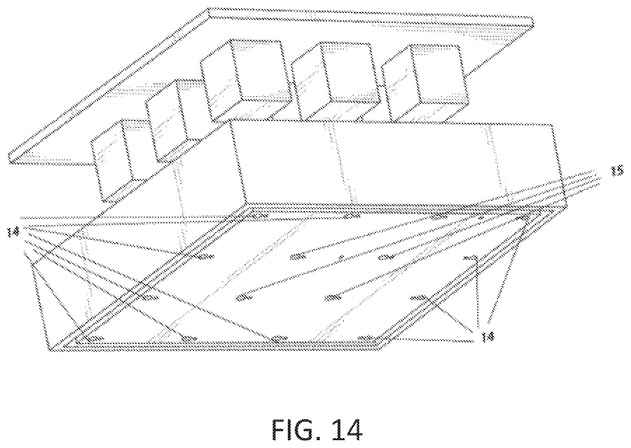

In various embodiments, the press 2 and the press receiver 7 respectively comprise cooking surfaces. These respective cooking surfaces may be made from a variety of materials, such as stainless steel and/or aluminum, and may be coated with a nonstick cooking layer. In various embodiments, one or both of the top housing 12 and the bottom housing 10 include a heater (e.g., a heating element). Said differently, the one or more heater elements may be incorporated into (e.g., operably coupled to) the press and/or the press receiver. In various embodiments, the one or more heaters of the apparatus include an electrical filament that generates heats as electronic current is passed therethrough (e.g., FIG. 12). The one or more heaters of the apparatus 100 may include an external heating source, such as a burner plate, flame, or oven, or other features that is able to transfer heat into the batter via the press and/or press receiver. In various embodiments, a plurality of heating elements 11 are placed into heating element apertures 14 in a configuration to generally evenly spread heat throughout the apparatus. In various embodiments, the heating element apertures 14 within the various components of the apparatus are arranged within the press receiver 7 as depicted in FIG. 14. In various embodiments, each press protrusion 8 has one heating element aperture 14 centrally located within to accommodate one heating element 11.

In various embodiments, the apparatus incorporates heating element 11 as a sub-component of the bottom housing 10. The heating element may be a 120 volt AC, one-quarter inch diameter, one inch long, 80 watt cartridge heater with lead covering. In various embodiments, the heating element 11 is a 120 volt AC, three-eighths inch diameter, two inch long (or alternatively one and one half inch long) cartridge heater. In various configurations, the heating element 11 may have a wattage between 100 watts and 200 watts. In various embodiments, the heating element 11 comprises a three-eighths diameter, one and one half inch long cartridge heater is placed within a press protrusion 8. In various embodiments, a heating element 11 comprising a three-eighths diameter, two-inch long cartridge heater is placed within a press receiver 7. In various embodiments, the heating element 11 is configured for use with a temperature controller, optionally forming a part of the system.

In various embodiments, the apparatus 100 and/or system 50 further includes a plurality of temperature sensors. In various embodiments, the temperature sensors comprise “K-type” temperature sensors (thermocouples). In various embodiments, the temperature sensors are connected to a computer processing unit configured to learn and control the plurality of heating elements 11. For example, the temperature sensors operating in concert with the computer processing unit allow for internal monitoring of the sensors to adjust the heating elements to maintain a consistent temperature near the outer edge of the unit and compensate for the heat loss through the outer edge wall of embodiments of the invention. In various embodiments, heating elements 11 closer to the outside edge (for instance the heating elements 11 placed in the outer heating element apertures 14 depicted by FIG. 14) may be configured to generate more heat than the heating elements 11 closer to the inner core of the invention (for instance, the heating elements 11 placed in the inner heating element apertures 15 comprising the inner square depicted by FIG. 14) to accommodate for the additional cooling that occurs at the periphery of the apparatus. In various embodiments, the press 2 incorporates one temperature sensor, and the press receiver 7 incorporates two temperature sensors. Combining the temperature sensors with a controller may enable automated control of the cooking process, and thus the system may include additional mechanism for automating the process of cooking and forming the edible containers. For example, the system may include one or more lift mechanisms to automate lifting the top housing.

In various embodiments, the press protrusion 8 comprises the following dimensions: two and one-sixteenth inches high, one and thirteen-sixteenths inches in each length dimension forming a downward square protrusion from the main body of the press 2. In various embodiments, the press protrusions 8 incorporate steel and/or aluminum in its composition. In various embodiments, the press protrusion receptacle 9 comprises the following dimensions: two and three quarter inches square and two and three-eighths inches deep. In various embodiments, the press protrusion receptacle 9 incorporates steel and/or aluminum coated with a nonstick coating in its composition. In various embodiments, the press protrusion receptacle 9 is a square shaped void, designed to receive batter prior to cooking operations and thereafter receive a press protrusion 8 within the batter contained within, to facilitate cooking of the batter contained within into a predetermined shape. In various embodiments, the press protrusion receptacle(s) 9 and press protrusion(s) 8 are related. A press protrusion receptacle 9 and a press protrusion 8 are related to one another in such embodiment by the press protrusion 8 relates to the press protrusion 8 receptacle 9 by fitting within the press protrusion 8 receptacle 9 without coming into contact with the press protrusion 8 receptacle 9, the void created there between Tillable with a batter during cooking operations to provide a form for the resulting cooked batter.

The bottom housing 10 may be sized and according to the specifics of a given application. In various embodiments, the bottom housing has dimensions of ten inches square with a height of three inches. In various embodiments, the bottom housing 10 is made from stainless steel and/or aluminum. A plurality of heating elements 11 may be housed within and/or mounted to the bottom housing 10. The bottom housing 10, according to various embodiments, may define a receptacle designed to hold a removable tray 5. In various embodiments, the An embodiment of the invention additionally incorporates a top housing 12. The top housing 12 may have dimensions that generally conform to the dimensions of the bottom housing 10, as described in greater detail below. In various embodiments, it may be beneficial for the top housing 12 and the bottom housing 10 to have a similar/consistent size. For example, with the top housing 12 and the bottom housing 10 having a similar size, the cost of production may be reduced. In various embodiments, the press receiver 7 comprises the following dimensions: approximately eight inches square, incorporating four press protrusion receptacles of a size of approximately 2¾ inches square and 2⅜ inches deep.

In various embodiments, either the bottom housing 10 or the top housing 12, or both, incorporate holes. In various embodiments, either or both the top housing 12 and the bottom housing 10 are configured to house a plurality of wires or wire portions. In various embodiments, the holes are specifically configured and of a dimension to allow wires to travel through. In various embodiments, a wire attached to one or more temperature sensors travels through a hole in either the top housing 12 or bottom housing 10. In various embodiments, one of the top housing 12 and bottom housing 10 incorporates one or more gripping teeth 16. In various embodiments, one of the top housing 12 and bottom housing 10 incorporates one or more gripping teeth apertures 17 of a size and placement configured to accommodate the one or more gripping teeth 16. In various embodiments, incorporation of the one or more gripping teeth 16 and the one or more gripping teeth apertures 17 into the top housing 12 and/or the bottom housing 10 solves the problem that occurs when waffles rise during cooking, that the components of the system rise in an uneven or uncontrolled manner. In various embodiments, the gripping teeth 16 and the gripping teeth apertures 17 have dimensions of one inch by one inch with a six degree interior angle starting one-eighth inch from the flat surface. In such embodiments, the interaction of the gripping teeth 16 and the gripping teeth apertures 17 advantageously function and do not lead to the metal components sticking together in an undesirable fashion.

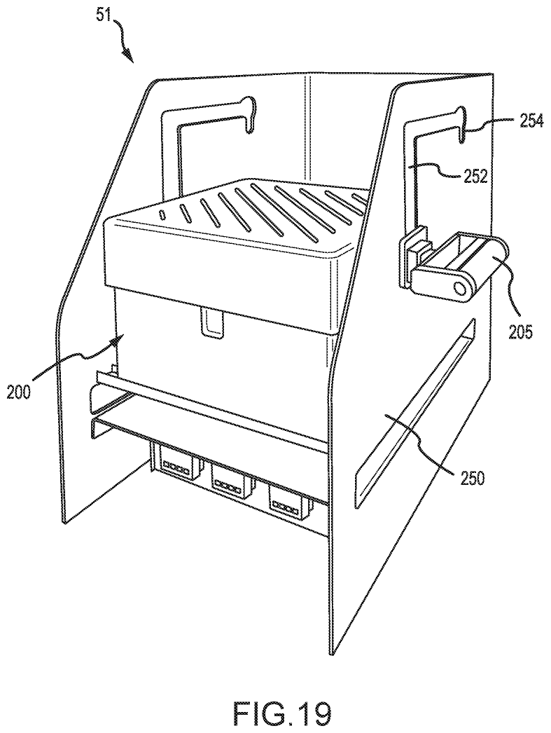

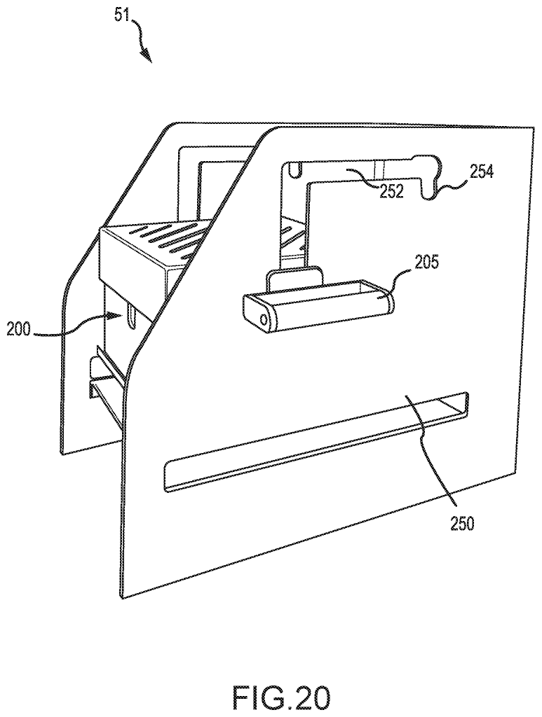

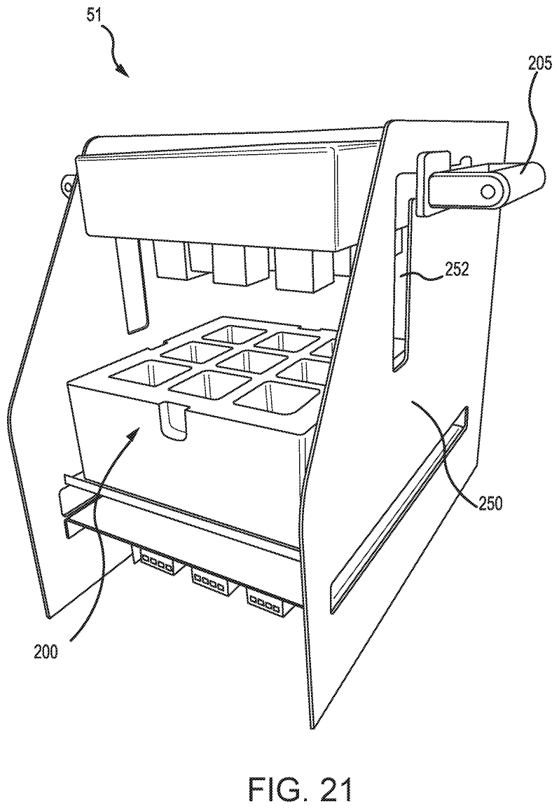

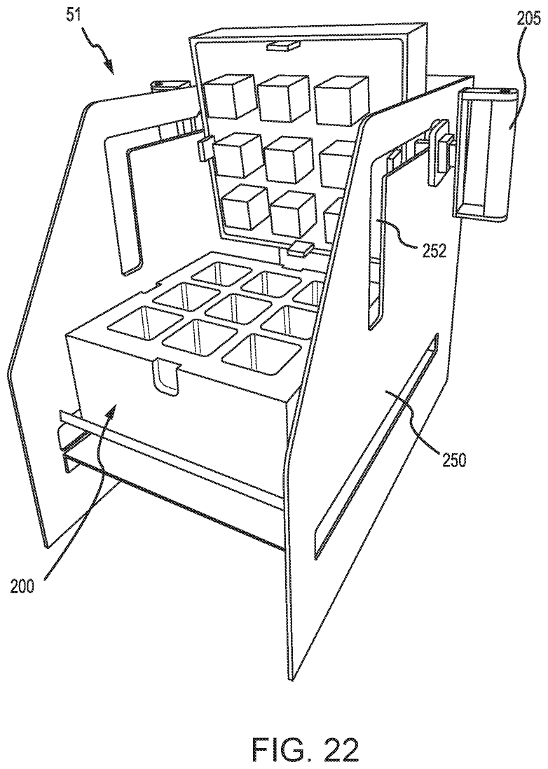

In various embodiments, and with reference to FIGS. 19-22, the system 51 includes frame 250 and apparatus 200. In various embodiments, the top housing is not directly coupled to the bottom housing, and instead may include handles 205 or other features that are configured to movably slide within a guide track 252 of the frame 250. The guide track 252 of the frame 250 may include a first portion (e.g., vertical portion) that facilitates an initial linear upward translation (e.g., FIG. 21) of the top housing, thereby preventing the walls of the cooked, formed edible containers remaining in the press receptacles of the press receiver/bottom housing from being compressed or otherwise damaged if a pivoting or arcuate motion were utilized. In various embodiments, the guide track 252 may include a second portion, which may be substantially perpendicular to the first portion, that facilitates movement of the top housing 12 away from the bottom housing 10 to allow the user access to the cooked edible container(s). In various embodiments, the guide track 252 may include a notch 254 or other feature configured to facilitate securing the top housing 12 in a removed position (e.g., the handles 205 may be received within the notches 254).

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure.

The scope of the disclosure is accordingly to be limited by nothing other than the appended claims, in which reference to an element in the singular is not intended to mean “one and only one” unless explicitly so stated, but rather “one or more.” It is to be understood that unless specifically stated otherwise, references to “a,” “an,” and/or “the” may include one or more than one and that reference to an item in the singular may also include the item in the plural. All ranges and ratio limits disclosed herein may be combined.

Moreover, where a phrase similar to “at least one of A, B, and C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Also, any reference to attached, fixed, connected, coupled or the like may include permanent (e.g., integral), removable, temporary, partial, full, and/or any other possible attachment option. Different cross-hatching is used throughout the figures to denote different parts but not necessarily to denote the same or different materials.

The steps recited in any of the method or process descriptions may be executed in any order and are not necessarily limited to the order presented. Furthermore, any reference to singular includes plural embodiments, and any reference to more than one component or step may include a singular embodiment or step. Elements and steps in the figures are illustrated for simplicity and clarity and have not necessarily been rendered according to any particular sequence. For example, steps that may be performed concurrently or in different order are illustrated in the figures to help to improve understanding of embodiments of the present disclosure.

Any reference to attached, fixed, connected or the like may include permanent, removable, temporary, partial, full and/or any other possible attachment option. Additionally, any reference to without contact (or similar phrases) may also include reduced contact or minimal contact. Surface shading lines may be used throughout the figures to denote different parts or areas but not necessarily to denote the same or different materials. In some cases, reference coordinates may be specific to each figure.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. An apparatus for cooking and forming an edible food container, the apparatus comprising:
a bottom housing comprising a press receiver defining at least one press receptacle;
a top housing comprising a press defining at least one press protrusion, wherein the top housing is moveable relative to the bottom housing; and
a heating element incorporated into at least one of the top housing and the bottom housing.

2. A system for cooking and forming an edible food container, the system comprising:
a bottom housing comprising a press receiver defining at least one press receptacle;
a top housing comprising a press defining at least one press protrusion;
a heating element incorporated into at least one of the top housing and the bottom housing; and
a frame, wherein the top housing is moveable relative to the bottom housing via engagement with the frame.

3. The system of claim 2, wherein:
the top housing comprises a handle;
the frame comprises a guide track; and
the handle of the top housing is received within the guide track.

4. The system of claim 3, wherein the guide track comprises a notch configured to securely yet reversibly retain the handle, and thus the top housing, in a removed position relative to the bottom housing.

5. The system of claim 3, wherein the guide track comprises a first vertical portion such that movement of the top housing relative to the bottom housing is a linear upward translation.

6. A method for cooking and forming an edible food container, the method comprising:
removing a top housing a distance from a bottom housing;
pouring a batter into at least one press receptacle defined by a press receiver of a the bottom housing; and
approximating the top housing relative to the bottom housing to compress the batter between walls of the at least one press receptacle and a press protrusion of a press of the top housing.

7. The method of claim 6, wherein removing the top housing the distance from the bottom housing comprises a linear upward translation of the top housing relative to the bottom housing.
